(19) United States
(12) Patent Application Publication
(10) Pub. No.: US 2015/0142659 A1
(43) Pub. Date: May 21, 2015

(54) METHOD, APPARATUS AND SYSTEM FOR MOBILE PAYMENT

(71) Applicant: TENCENT TECHNOLOGY (SHENZHEN) COMPANY LIMITED, Shenzhen (CN)

(72) Inventor: WEI SHI, Shenzhen (CN)

(73) Assignee: TENCENT TECHNOLOGY (SHENZHEN) COMPANY LIMITED

(21) Appl. No.: 14/462,784

(22) Filed: Aug. 19, 2014

Related U.S. Application Data
(63) Continuation of application No. PCT/CN2014/079342, filed on Jun. 6, 2014.

(30) Foreign Application Priority Data
Nov. 15, 2013 (CN) 201310574649.X

(51) Int. Cl. G06Q 20/32; G06Q 20/40

(52) U.S. Cl. CPC G06Q 20/3226; G06Q 20/4014
USPC 705/44

(57) ABSTRACT

A mobile payment method is provided. The method includes a mobile terminal obtaining a user identifier stored in a portable terminal which establishes a communication connection with the mobile terminal and sending the user identifier to a payment platform server. The method also includes the mobile terminal receiving prompt information sent from the payment platform server, where the prompt information is used to prompt the mobile terminal to report payment information after the payment platform server authenticates successfully the user identifier sent from the mobile terminal. Further, the method includes the mobile terminal receiving the payment information inputted by a user in response to the prompt information and sending the payment information to the payment platform server to cause the payment platform server to perform a payment operation based on the payment information, where the payment information includes a payment account, a payment amount and a beneficiary account.

### CROSS-REFERENCES TO RELATED APPLICATIONS

This application is a continuation application of PCT Patent Application No. PCT/CN2014/079342, filed on Jun. 6, 2014, which claims priority of Chinese Patent Application No. 201310574649.X, filed on Nov. 15, 2013, the entire contents of all of which are incorporated by reference herein.

### FIELD OF THE INVENTION

The present invention generally relates to the field of Internet technologies and, more particularly, to methods, apparatuses and systems for mobile payment.

### BACKGROUND

With the rapid development of Internet technologies, online payments using a mobile terminal, such as a smartphone (e.g., an Android mobile phone, an iOS mobile phone, etc.), a Tablet personal computer (PC), a Pocket PC, a Mobile Internet Devices (MID) and a Personal Access Device (PAD), become a convenient and popular payment method. However, in practical applications, when the mobile terminal is attacked by a Trojan virus, the security of the online payments using the mobile terminals cannot be guaranteed.

The disclosed methods, apparatuses, and systems are directed to solve one or more problems set forth above and other problems.

### BRIEF SUMMARY OF THE DISCLOSURE

One aspect of the present disclosure includes a mobile payment method. The method includes a mobile terminal obtaining a user identifier stored in a portable terminal which establishes a communication connection with the mobile terminal and sending the user identifier to a payment platform server. The method also includes the mobile terminal receiving prompt information sent from the payment platform server, where the prompt information is used to prompt the mobile terminal to report payment information after the payment platform server authenticates successfully the user identifier sent from the mobile terminal. Further, the method includes the mobile terminal receiving the payment information inputted by a user in response to the prompt information and sending the payment information to the payment platform server to cause the payment platform server to perform a payment operation based on the payment information, where the payment information includes a payment account, a payment amount and a beneficiary account.

Another aspect of the present disclosure includes a mobile terminal. The terminal includes an obtaining unit configured to obtain a user identifier stored in a portable terminal which establishes a communication connection with the mobile terminal. The terminal also includes a receiving and sending unit configured to send the user identifier to a payment platform server and receive prompt information sent from the payment platform server, where the prompt information is used to prompt the mobile terminal to report payment information, and the prompt information is information sent from the payment platform server to the mobile terminal when the user identifier is authenticated successfully by the payment platform server. Further, the terminal includes the receiving and sending unit also configured to receive the payment information inputted by a user in response to the prompt information, and send the payment information to the payment platform server to cause the payment platform server to perform a payment operation based on the payment information, where the payment information includes a payment account, a payment amount, and a beneficiary account.

Another aspect of the present disclosure includes a mobile payment system. The system includes a portable terminal configured to store a user identifier. The system also includes a mobile terminal configured to obtain the user identifier stored in the portable terminal and send the user identifier to a payment platform server. Further, the system includes the mobile terminal also configured to receive payment information inputted by a user in response to prompt information, and send the payment information to the payment platform server; where the payment information includes a payment account, a payment amount and a beneficiary account. In addition, the system includes the payment platform server configured to receive the user identifier sent from the mobile terminal, and authenticate the user identifier, where the payment platform server sends the prompt information to the mobile terminal when the authentication is successful, and the prompt information is used to prompt the mobile terminal to report the payment information. The system includes the payment platform server also configured to receive the payment information sent from the mobile terminal and perform a payment operation based on the payment information.

Other aspects of the present disclosure can be understood by those skilled in the art in light of the description, the claims, and the drawings of the present disclosure.

### BRIEF DESCRIPTION OF THE DRAWINGS

In order to describe the technical solution of the embodiments of the present invention more clearly, drawings used in the description of the embodiments are introduced below. The drawings described below are merely some exemplary embodiments of the present invention. For those skilled in the art, on the premise of no inventive effort being involved, other drawings may also be obtained according to these drawings and the descriptions included herein.

FIG. 1 illustrates a flow chart of an exemplary mobile payment process consistent with the disclosed embodiments;

FIG. 2 illustrates a schematic diagram of an exemplary interface that a mobile terminal displays prompt information sent by a payment platform server consistent with the disclosed embodiments;

FIG. 3 illustrates a flow chart of another exemplary mobile payment process consistent with the disclosed embodiments;

FIG. 4 illustrates a flow chart of another exemplary mobile payment process consistent with the disclosed embodiments;

FIG. 5 illustrates a structure diagram of an exemplary mobile terminal consistent with the disclosed embodiments;

FIG. 6 illustrates a structure diagram of another exemplary mobile terminal consistent with the disclosed embodiments; and

FIG. 7 illustrates a schematic diagram of an exemplary mobile payment system consistent with the disclosed embodiments.

### DETAILED DESCRIPTION

In the following description, for purposes of illustration, many specific details are illustrated in order to provide a full understanding of one or more embodiments. However, obviously, those embodiments can also be implemented in the case of these specific details changed, replaced, or alternated. The followings, together with accompanying drawings, describe in detail certain embodiments of the present invention.

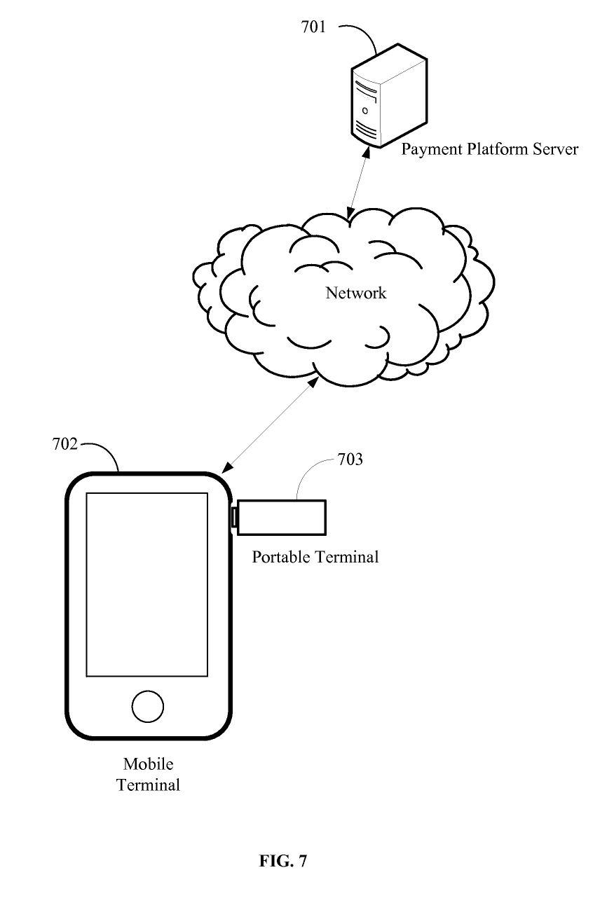

FIG. 7 illustrates a schematic diagram of an exemplary mobile payment system consistent with the disclosed embodiments. As shown in FIG. 7, the mobile payment system may include a payment platform server 701, a mobile terminal 702, and a portable terminal 703 which establishes a communication connection with the mobile terminal 702, where the payment platform server 701 connects to the mobile terminal 702 through, for example, the Internet.

The portable terminal 703 is a secure payment hardware device with a unique identifier, where the user identifier stored in the portable terminal 703 may be a user identifier that changes periodically. The portable terminal 703 includes at least a memory which stores the user identifier and a communication module which establishes a communication connection with the mobile terminal 702. There are no specific limitations on the portable terminal.

The mobile terminal 702 is configured to obtain the user identifier stored in the portable terminal 703 and sends the user identifier to the payment platform server 701. The mobile terminal 702 can be a smartphone (e.g., an Android mobile phone, an iOS mobile phone, etc.), a Tablet personal computer (PC), a Pocket PC, a Portable Multimedia Player (PMP), a Mobile Internet Device (MID) and a Personal Access Device (PAD). There are no specific limitations on the mobile terminal.

The communication connection between the mobile terminal 702 and the portable terminal 703 may be established via a headphone port, a charging port, a Bluetooth module, a wireless fidelity (Wi-Fi) module, or a near field communication (NFC) module of the mobile terminal 702.

The payment platform server 701 is configured to receive the user identifier sent from the mobile terminal 702, authenticate the user identifier, and send prompt information to the mobile terminal 702 when the authentication is successful, where the prompt information is used to prompt the mobile terminal 702 to report payment information.

The mobile terminal 702 is also configured to receive the payment information inputted by the user in response to the prompt information, and send the payment information to the payment platform server 701. The payment information may include a payment account, a payment amount and a beneficiary account.

The payment platform server 701 is also configured to receive the payment information sent from the mobile terminal 702 and perform a payment operation based on the payment information.

In certain embodiments, the mobile terminal 702 is also configured to, before obtaining the user identifier stored in the portable terminal 703, detect an identification authentication start instruction inputted by the user, respond to the identification authentication start instruction, and perform the steps for obtaining the user identifier stored in the portable terminal.

In certain embodiments, the mobile terminal 702 is also configured to, before detecting the identification authentication start instruction, establish the communication connection with the portable terminal 703.

In certain embodiments, the portable terminal 703 is also configured to store an encryption algorithm and an encryption key.

The mobile terminal 702 is also configured to, after receiving the payment information inputted by the user in response to the prompt information, send the payment information to the portable terminal 703.

The portable terminal 703 is also configured to, after receiving the payment information sent from the mobile terminal 702, encrypt the payment information by using the encryption algorithm and the encryption key stored in the portable terminal.

The portable terminal 703 is also configured to send the encrypted payment information to the mobile terminal 702.

The mobile terminal 702 is also configured to receive the encrypted payment information sent from the portable terminal 703, and send the encrypted payment information to the payment platform server 701.

The payment platform server 701 is also configured to receive the encrypted payment information sent from the mobile terminal 702, decrypt the encrypted payment information, and perform the payment operation.

In the mobile payment system shown in FIG. 7, by using the portable terminal to store the user identifier, a hardware-based security is implemented, thereby effectively improving the security of the mobile payment process.

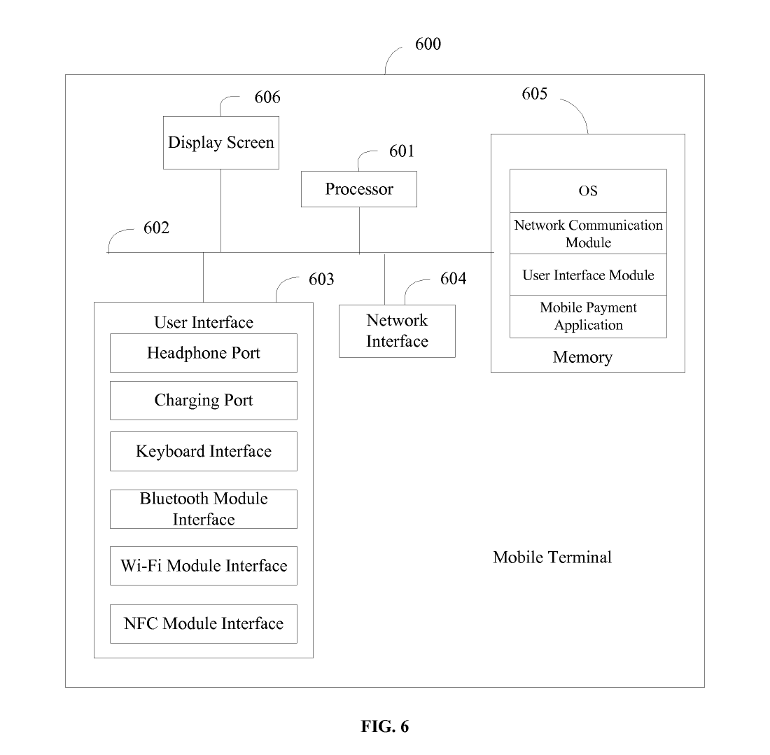

FIG. 6 illustrates a structure diagram of an exemplary mobile terminal consistent with the disclosed embodiments. As show in FIG. 6, the mobile terminal 600 may include at least one processor 601 (e.g., Central Processing Unit) , at least one communication bus 602, a user interface 603, at least one network interface 604, a memory 605, and a display screen 606.

The network interface 604, the memory 605, the processor 601, the user interface 603, and a display screen 606 communicate with each other via one or more communication buses 602.

The user interface 603 may include a headphone port, a charging port, a keyboard, and other wired communication. The user interface 603 may also include standard wireless interface(s), such as a Bluetooth module, a Wi-Fi module, and an NFC module.

The network interface 604 may be an interface of a communication module, such as an interface of a network card. The network interface 604 may include wired communication port(s) and/or wireless transmission and reception circuitry. The wired communication port(s) receive and send communication signals via one or more wired interfaces, e.g., Ethernet,

Universal Serial Bus (USB), FIREWIRE, etc. The wireless circuitry receives and sends Radio Frequency (RF) signals and/or optical signals from/to communications networks and other communications devices. The wireless communications may use any of a plurality of communications standards, protocols and technologies, such as Global System for Mobile (GSM), Enhanced Data rates for GSM Evolution (EDGE), Code Division Multiple Access (CDMA), Time Division Multiple Access (TDMA), Wideband Code Division Multiple Access CDMA (WCDMA), Long Term Evolution (LTE), Bluetooth, wireless fidelity (Wi-Fi), Voice over Internet Protocol (VoIP), Worldwide Interoperability for Microwave Access (Wi-MAX), or any other suitable communication protocol.

The memory 605 is configured to store software programs, modules, instructions, and data structures. The one or more processors 601 are coupled to the memory 605 and operable to execute these programs, modules, and instructions, and read/write from/to the data structures stored in the memory 605 for implementing various functions of the mobile payment. The memory 605 includes a memory program area and a memory data area. The memory program area stores operating systems, network communication modules, user interface modules, applications (such as mobile payment applications, etc.), and so on. For example, an operating system includes various software components and/or drivers for controlling and managing general system tasks (e.g., memory management, storage device control, power management, etc.) and facilitates communications between various hardware, firmware, and software components.

The memory 605 may include high-speed random access memory (RAM), such as DRAM, SRAM, or other random access solid state memory devices. The memory 605 may also include non-volatile memory, such as one or more magnetic disk storage devices, optical disk storage devices, flash memory devices, or other non-volatile solid state storage devices.

The processor 601 may include any appropriate processor or processors. Further, the processor 601 can include multiple cores for multi-thread or parallel processing. The processor may be General Processor, central processing unit (CPU), Microprogrammed Control Unit (MCU), digital signal processor (DSP), graphics processing unit (GPU), system on a chip (SOC), application specific integrated circuits (ASIC), etc. The processor 601 is configured to execute the following operations by calling a mobile payment application stored in the memory 605.

In the mobile terminal 600 described in FIG. 6, the network interface 604 is configured to connect a payment platform server, and perform data communication with the payment platform server. The processor 601 may be configured to call the mobile payment application stored in the memory 605 and perform the :certain mobile payment processes.

For example, the mobile terminal 600 (e.g., processor 601) may obtain a user identifier stored in a portable terminal which establishes the communication connection with the mobile terminal 600 via the user interface 603, and sends the user identifier to the payment platform server via the network interface 604.

Further, the mobile terminal 600 receives prompt information sent by the payment platform server via the network interface 604 and displays the prompt information via the display screen 606. The prompt information is used to prompt the mobile terminal 600 to report payment information. The prompt information is information sent from the payment platform server to the mobile terminal 600 when the user identifier is authenticated successfully.

Further, the mobile terminal 600 receives the payment information inputted by the user in response to the prompt information displayed by the display screen 606 via the user interface 603 (e.g., a keyboard), and sends the payment information to the payment platform server via the network interface 604, such that the payment platform server performs a payment operation based on the payment information. The payment information includes a payment account, a payment amount and a beneficiary account.

The communication connection can be established via a headphone port, a charging port, a Bluetooth module, a Wi-Fi module or an NFC module.

In certain embodiments, the processor 601 is configured to call a mobile payment application stored in the memory 605. :Before obtaining the user identifier stored in the portable terminal which establishes the communication connection with the mobile terminal 600 via the user interface 603, the mobile terminal 600 detects an identification authentication start instruction inputted by the user (inputted through the display screen 606 or the user interface 603); responds to the identification authentication start instruction; and obtains the user identifier stored in the portable terminal which establishes the communication connection with the mobile terminal 600 via the user interface 603.

In certain embodiments, the processor 601 is configured to call the mobile payment application stored in the memory 605 and establish the communication connection with the portable terminal via the user interface 603 before detecting the identification authentication start instruction inputted by the user.

In certain embodiments, the processor 601 is configured to call the mobile payment application stored in the memory 605 and perform certain mobile payment processes.:

For example, after receiving the payment information via the user interface 603 (the payment information is inputted by the user in response to the prompt information displayed by the display screen 606), the mobile terminal 600 sends the payment information to the portable terminal via the user interface 603 (e.g., a Wi-Fi module interface), such that the portable terminal can encrypt the payment information using an encryption algorithm and an encryption key stored in the portable terminal and also sends the encrypted payment information to the mobile terminal 600.

Further, the mobile terminal 600 receives the encrypted payment information sent by the portable terminal via the user interface 603 (e.g., a Wi-Fi module interface) and sends the encrypted payment information to the payment platform server via the network interface 604, such that the payment platform server can decrypt the encrypted payment information and perform the payment operation.

The user identifier stored in the portable terminal may be an identifier that changes periodically. Thus, in the mobile terminal shown in FIG. 6, by using the portable terminal to store the user identifier, a hardware-based security is implemented, thereby effectively improving the security of the mobile payment process.

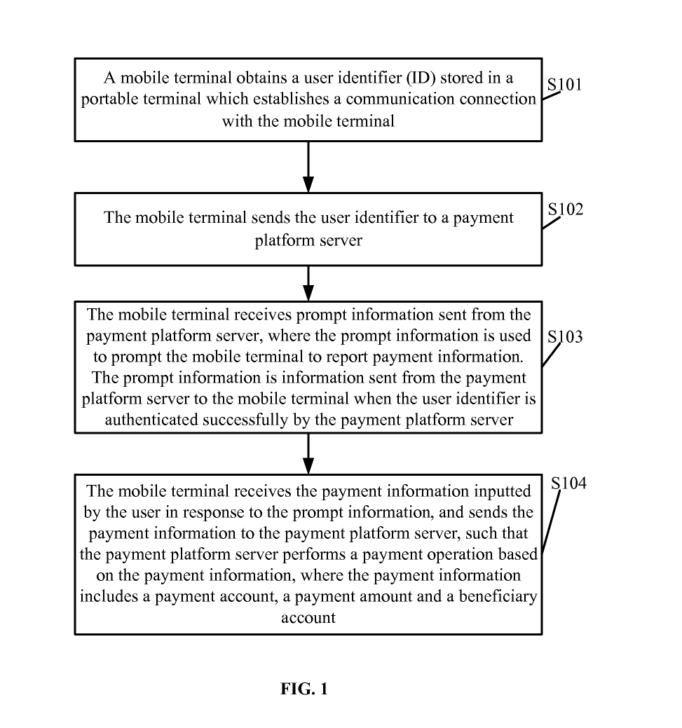

FIG. 1 illustrates a flow chart of an exemplary mobile payment process consistent with the disclosed embodiments. The mobile payment process is described from a mobile terminal side. The mobile terminal can be a smartphone (e.g., an Android mobile phone, an iOS mobile phone, etc.), a Tablet personal computer (PC), a Pocket PC, a Mobile Internet Device (MID) and a Personal Access Device (PAD). There are no specific limitations on the mobile terminal. As shown in FIG. 1, the mobile payment process may include the following steps.

S101: a mobile terminal obtains a user identifier (ID) stored in a portable terminal which establishes a communication connection with the mobile terminal.

Specifically, when a user needs to make a payment, the user may establish the communication connection between the mobile terminal and the portable terminal that stores the user identifier, such that the mobile terminal can obtain the user identifier stored in the portable terminal which establishes the communication connection with the mobile terminal.

In the mobile payment process described in FIG. 1, before the mobile terminal performs S101, the mobile terminal may also perform the following steps.

Step 11: the mobile terminal detects an identification authentication start instruction inputted by the user.

Step 12: the mobile terminal responds to the identification authentication start instruction, and performs S101 (that is, a mobile terminal obtains a user identifier stored in a portable terminal which establishes a communication connection with the mobile terminal).

In the mobile payment process described in FIG. 1, before the mobile terminal performs Step 11, the mobile terminal may also establish the communication connection with the portable terminal.

The mobile terminal establishes the communication connection with the portable terminal through the following ways:

A: the mobile terminal establishes the communication connection with the portable terminal via a headphone port of the mobile terminal. That is, the portable terminal plugs directly into the headphone port of the mobile terminal (e.g., an iPhone, an iPad, or an Android device).

B: the mobile terminal establishes the communication connection with the portable terminal via a charging port of the mobile terminal. That is, the portable terminal plugs directly into the charging port of the mobile terminal (e.g., an iPhone, an iPad, or an Android device).

C: the mobile terminal establishes the communication connection with the portable terminal via a Bluetooth module of the mobile terminal. For example, a user may connect a portable terminal to a mobile terminal (e.g., an iPhone, an iPad, or an Android device) equipped with a Bluetooth module via Bluetooth protocols.

D: the mobile terminal establishes the communication connection with the portable terminal via a wireless fidelity (Wi-Fi) module of the mobile terminal. For example, a user may connect a portable terminal to a mobile terminal (e.g., an iPhone, an iPad, or an Android device) equipped with a Wi-Fi module via Wi-Fi wireless network protocols (e.g., Wi-Fi IEEE 802.11a, IEEE 802.11b, IEEE 802.11g or IEEE 802.11n).

E: the mobile terminal establishes the communication connection with the portable terminal via a near field communication (NFC) module of the mobile terminal. Near field communication (NFC) is a set of standards for smartphones and similar devices to establish radio communication with each other by touching them together or bringing them into proximity, usually no more than a few inches. For example, a user may hold a portable terminal near a mobile terminal (e.g., an Android device) equipped with an NFC module to establish the communication connection.

The portable terminal may be provided by a payment card promoter. The user identifier stored in the portable terminal includes, but not limited to, a string (e.g., 859654, aBc1, etc.), a sentence, etc. There are no specific limitations on the user identifier stored in the portable terminal. In certain embodiments, the user identifier may be a user identifier that changes periodically.

S102: the mobile terminal sends the user identifier to a payment platform server.

Specifically, the mobile terminal may send the user identifier to the payment platform server via various networks (e.g., Internet, Intranet, wireless network). There are no specific limitations on the methods for sending the payment information.

S103: the mobile terminal receives prompt information sent from the payment platform server, where the prompt information is used to prompt the mobile terminal to report payment information. The prompt information is information sent from the payment platform server to the mobile terminal when the user identifier is authenticated successfully by the payment platform server.

In certain embodiments, when the user identifier is a string, a payment platform server may determine whether the string is the same as a stored string. If the string is the same as the stored string, the payment platform server may send the prompt information to the mobile terminal, where the prompt information is used to prompt the mobile terminal to report the payment information.

In certain embodiments, when the user identifier is a string, a payment platform server may determine whether arrangement rules of characters in the string meet predetermined character arrangement rules. If the arrangement rules of the characters in the string meet the predetermined character rules, the payment platform server may send the prompt information to the mobile terminal, where the prompt information is used to prompt the mobile terminal to report the payment information.

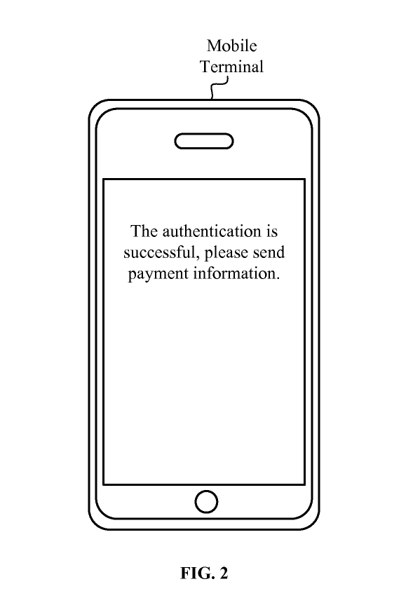

After the mobile terminal receives the prompt information sent from the payment platform server, the mobile terminal may output the prompt information using a text format and/or a voice format. FIG. 2 illustrates a schematic diagram of an exemplary interface that a mobile terminal displays prompt information sent by a payment platform server consistent with the disclosed embodiments.

As shown in FIG. 2, the mobile terminal outputs the prompt information “The authentication is successful, please send payment information” using a text format and/or a voice format, such that the user can respond the prompt information and input the payment information on the mobile terminal.

S104: the mobile terminal receives the payment information inputted by the user in response to the prompt information, and sends the payment information to the payment platform server, such that the payment platform server performs a payment operation based on the payment information, where the payment information includes a payment account, a payment amount and a beneficiary account.

The mobile terminal may send the payment information to the payment platform server via various networks (e.g., Internet, Intranet, wireless network). There are no specific limitations on the methods for sending the payment information.

After the payment platform server receives the payment information sent from the mobile terminal, the payment platform server may deduct the payment amount from the payment account included in the payment information, and send the payment amount to the beneficiary account.

In the mobile payment process described in FIG. 1, after the mobile terminal receives the payment information inputted by the user in response to the prompt information, the mobile terminal may also perform the following steps.

Step 21: the mobile terminal sends the payment information to the portable terminal, such that the portable terminal encrypts the payment information by using an encryption algorithm and an encryption key stored in the portable terminal, as well as sends the encrypted payment information to the mobile terminal.

Step 22: the mobile terminal receives the encrypted payment information sent from the portable terminal and sends the encrypted payment information to the payment platform server, such that the payment platform server can decrypt the encrypted payment information and perform the payment operation.

By performing the Step 21 and the Step 22, the payment security is better improved, maintaining a secure payment environment for the user.

In certain embodiments, when a user needs to make a payment, the user establishes a communication connection between the portable terminal and a mobile terminal. The mobile terminal with an app (or a payment webpage) that is tied to a credit card or stores an account obtains a user identifier (ID) stored in the portable terminal which establishes the communication connection with the mobile terminal through a headphone port, a charging port, a

Bluetooth module, a wireless fidelity (Wi-Fi) module, or a near field communication (NFC) module.

The app (or the payment webpage) can load security controls of the portable terminal to authenticate the user and protect user data using an encryption key and an encryption algorithm stored in the portable terminal. The mobile terminal may also provide the user a third party payment environment by directly calling a preset payment environment of the portable terminal. Then, the payment platform server interacts with the app (or a payment webpage) via various networks (e.g., Internet, Intranet, wireless network). According to the above mobile payment process, the transaction is processed and the charge is made against a credit card account of the user.

The mobile terminal obtains the user identifier (ID) stored in the portable terminal which establishes the communication connection with the mobile terminal. The mobile terminal sends the user identifier to the payment platform server. The payment platform server authenticates the user identifier and sends the prompt information to the mobile terminal after the authentication is successful, where the prompt information is used to prompt the mobile terminal to report the payment information. After the mobile terminal receives the payment information inputted by the user in response to the prompt information, the mobile terminal sends the payment information to the payment platform server, such that the payment platform server performs the payment operation. In the payment process described in FIG. 1, by using the portable terminal to store the user identifier, a hardware-based security is implemented, thereby effectively improving the security of the mobile payment process.

Currently, a universal serial bus (USB)-Shield for Internet banking services connects to the personal computer via a USB port of the personal computer. Compared to a USB-Shield, the portable terminal can apply to mobile terminals with different user interfaces. The user interface may include a headphone port, a charging port, and other standard wireless interface(s), such as a Bluetooth module, a Wi-Fi module, and an NFC module. Therefore, the portable terminal not only ensures integrity and non-repudiation of online transactions, but also improves confidentiality and authenticity of online payments.

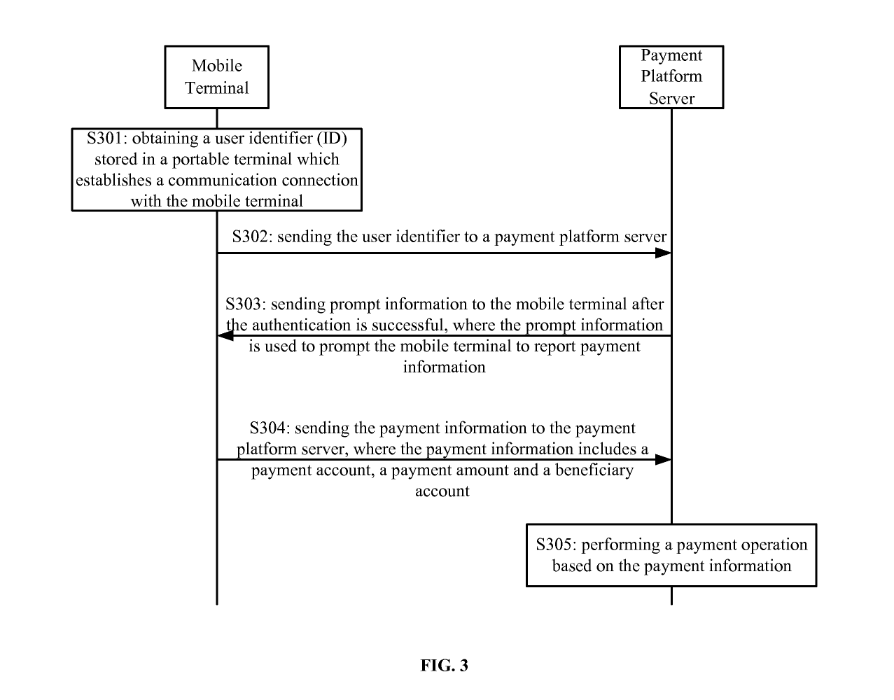

FIG. 3 illustrates a flow chart of another exemplary mobile payment process consistent with the disclosed embodiments. The mobile payment process is described from both a mobile terminal side and a payment platform server side. As show in FIG. 3, the process may include the following steps.

S301: a mobile terminal obtains a user identifier (ID) stored in a portable terminal which establishes a communication connection with the mobile terminal.

Specifically, when a user needs to make a payment, the user may establish the communication connection between the mobile terminal and the portable terminal that stores the user identifier, such that the mobile terminal can obtain the user identifier stored in the portable terminal.

Specifically, the portable terminal is provided by a payment card promoter. The user identifier stored in the portable terminal includes, but is not limited to, a string (e.g., 859654), a sentence, etc. There are no specific limitations on the user identifier stored in the portable terminal. In certain embodiments, the user identifier may be a user identifier that changes periodically.

S302: the mobile terminal sends the user identifier to a payment platform server.

Specifically, the mobile terminal may send the user identifier to the payment platform server via various networks (e.g., Internet, Intranet, wireless network). There are no specific limitations on the methods for sending the payment information.

S303: after the payment platform server receives the user identifier sent from the mobile terminal, the payment platform server authenticates the user identifier. If the authentication is successful, the payment platform server sends prompt information to the mobile terminal, where the prompt information is used to prompt the mobile terminal to report payment information.

In certain embodiments, when a user identifier is a string, a payment platform server may determine whether the string is the same as a stored string. If the string is the same as the stored string, the payment platform server sends prompt information to a mobile terminal, where the prompt information is used to prompt the mobile terminal to report payment information.

In certain embodiments, when a user identifier is a string, a payment platform server may determine whether arrangement rules of characters in the string meet predetermined character arrangement rules. If the arrangement rules of the characters in the string meet the predetermined character rules, the payment platform server sends prompt information to a mobile terminal, where the prompt information is used to prompt the mobile terminal to report payment information.

S304: the mobile terminal receives the payment information inputted by the user in response to the prompt information and sends the payment information to the payment platform server, where the payment information includes a payment account, a payment amount and a beneficiary account.

After the mobile terminal receives the prompt information sent from the payment platform server, the mobile terminal can output the prompt information using a text format and/or a voice format. FIG. 2 illustrates a schematic diagram of an exemplary interface that a mobile terminal displays prompt information sent by a payment platform server consistent with the disclosed embodiments. As shown in FIG. 2, the mobile terminal outputs the prompt information using a text format and/or a voice format: “The authentication is successful, please send payment information”, such that the user can respond to the prompt information and input the payment information on the mobile terminal.

The mobile terminal may send the payment information to the payment platform server via various networks (e.g., Internet, Intranet, wireless network). There are no specific limitations on the methods for sending the payment information.

S305: the payment platform server receives the payment information sent from the mobile terminal and performs a payment operation based on the payment information.

Specifically, after the payment platform server receives the payment information sent from the mobile terminal, the payment platform server may deduct the payment amount from the payment account included in the payment information, and send the payment amount to the beneficiary account.

In the payment process described in FIG. 3, by using the portable terminal to store the user identifier, a hardware-based security is implemented, thereby effectively improving the security of the mobile payment process.

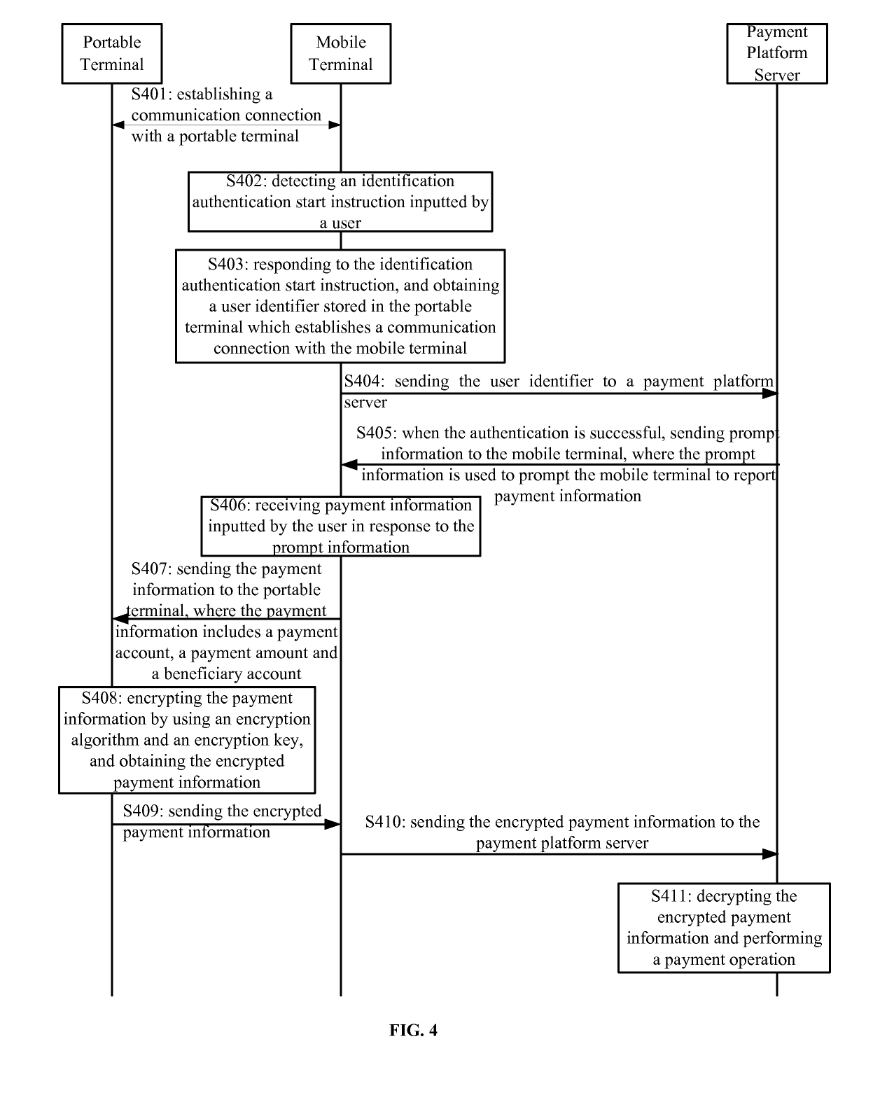

FIG. 4 illustrates a flow chart of another exemplary mobile payment process consistent with the disclosed embodiments. The mobile payment process is described from a portable terminal side, a mobile terminal side and a payment platform server side. As shown in FIG. 4, the process may include the following steps.

S401: a mobile terminal establishes a communication connection with a portable terminal. Specifically, the communication connection may be established by the following ways:

A: the mobile terminal establishes the communication connection with the portable terminal via a headphone port of the mobile terminal. That is, the portable terminal plugs directly into the headphone port of the mobile terminal (e.g., an iPhone, an iPad, or an

Android device).

B: the mobile terminal establishes the communication connection with the portable terminal via a charging port of the mobile terminal. That is, the portable terminal plugs directly into the charging port of the mobile terminal (e.g., an iPhone, an iPad, or an Android device).

C: the mobile terminal establishes the communication connection with the portable terminal via a Bluetooth module of the mobile terminal. For example, a user may connect a portable terminal to a mobile terminal (e.g., an iPhone, an iPad, or an Android device) equipped with a Bluetooth module via Bluetooth protocols.

D: the mobile terminal establishes the communication connection with the portable terminal via a Wi-Fi module of the mobile terminal. For example, a user may connect a portable terminal to a mobile terminal (e.g., an iPhone, an iPad, or an Android device) equipped with a Wi-Fi module via Wi-Fi wireless network protocols (e.g., Wi-Fi IEEE 802.11a, IEEE 802.11b, IEEE 802.11g or IEEE 802.11n).

E: the mobile terminal establishes the communication connection with the portable terminal via an NFC module of the mobile terminal. For example, a user may hold a portable terminal near a mobile terminal (e.g., an Android device) equipped with an NFC module to establish the communication connection.

S402: the mobile terminal detects an identification authentication start instruction inputted by a user.

S403: the mobile terminal responds to the identification authentication start instruction, and obtains a user identifier stored in the portable terminal which establishes a communication connection with the mobile terminal.

The portable terminal is provided by a payment card promoter. The user identifier stored in the portable terminal includes, but is not limited to, a string (e.g., 859654), a sentence, etc. There are no specific limitations on the user identifier stored in the portable terminal. In certain embodiments, the user identifier may be a user identifier that changes periodically.

S404: the mobile terminal sends the user identifier to a payment platform server. Specifically, the mobile terminal may send the user identifier to the payment platform server via various networks (e.g., Internet, Intranet, wireless network). There are no specific limitations on the methods for sending the payment information.

S405: after the payment platform server receives the user identifier sent from the mobile terminal, the payment platform server authenticates the user identifier. If the authentication is successful, the payment platform server sends prompt information to the mobile terminal, where the prompt information is used to prompt the mobile terminal to report payment information.

In certain embodiments, when a user identifier is a string, a payment platform server may determine whether the string is the same as a stored string. If the string is the same as the stored string, the payment platform server sends prompt information to a mobile terminal, where the prompt information is used to prompt the mobile terminal to report payment information.

In certain embodiments, when a user identifier is a string, a payment platform server may determine arrangement rules of characters in the string meet predetermined character arrangement rules. If the arrangement rules of the characters in the string meet the predetermined character rules, the payment platform server sends prompt information to a mobile terminal, where the prompt information is used to prompt the mobile terminal to report payment information.

In addition, after the payment platform server receives the user identifier sent from the mobile terminal, the payment platform server authenticates the user identifier. If the authentication is unsuccessful, the payment platform server sends warning information to the mobile terminal, prompting the user that the authentication is unsuccessful and the operation is not permitted.

S406: the mobile terminal receives payment information inputted by the user in response to the prompt information.

After the mobile terminal receives the prompt information sent from the payment platform server, the mobile terminal may output the prompt information using a text format and/or a voice format. FIG. 2 illustrates a schematic diagram of an exemplary interface that a mobile terminal displays prompt information sent by a payment platform server consistent with the disclosed embodiments. As shown in FIG. 2, the mobile terminal outputs the prompt information using a text format and/or a voice format: “The authentication is successful, please send payment information”, such that the user can respond to the prompt information and input the payment information on the mobile terminal.

S407: the mobile terminal sends the payment information to the portable terminal, where the payment information includes a payment account, a payment amount and a beneficiary account.

S408: after the portable terminal receives the payment information sent from the mobile terminal, the portable terminal encrypts the payment information by using an encryption algorithm and an encryption key stored in the portable terminal, and obtains the encrypted payment information.

Specifically, the encryption algorithm stored in the portable terminal may be a symmetric encryption algorithm or an asymmetric encryption algorithm.

S409: the portable terminal sends the encrypted payment information to the mobile terminal.

Specifically, when the mobile terminal establishes the communication connection with the portable terminal via a headphone port of the mobile terminal, the portable terminal sends the encrypted payment information to the mobile terminal via the headphone port; when the mobile terminal establishes the communication connection with the portable terminal via a charging port of the mobile terminal, the portable terminal sends the encrypted payment information to the mobile terminal via the charging port; when the mobile terminal establishes the communication connection with the portable terminal via a Bluetooth module of the mobile terminal, the portable terminal sends the encrypted payment information to the mobile terminal via the Bluetooth module; when the mobile terminal establishes the communication connection with the portable terminal via a Wi-Fi module of the mobile terminal, the portable terminal sends the encrypted payment information to the mobile terminal via the Wi-Fi module.

S410: the mobile terminal receives the encrypted payment information sent from the portable terminal and sends the encrypted payment information to the payment platform server.

Specifically, the mobile terminal may send the encrypted payment information to the payment platform server via various networks (e.g., Internet, Intranet, wireless network). There are no specific limitations on the methods for sending the payment information.

S411: the payment platform server receives the encrypted payment information sent from the mobile terminal, decrypts the encrypted payment information and performs a payment operation.

Specifically, after the payment platform server decrypts the encrypted payment information, the payment platform server can obtain the payment information inputted by the user. Further, the payment platform server may deduct the payment amount from the payment account included in the payment information, and send the payment amount to the beneficiary account.

In the payment process described in FIG. 4, by using the portable terminal to store the user identifier, a hardware-based security is implemented, thereby effectively improving the security of the mobile payment process.

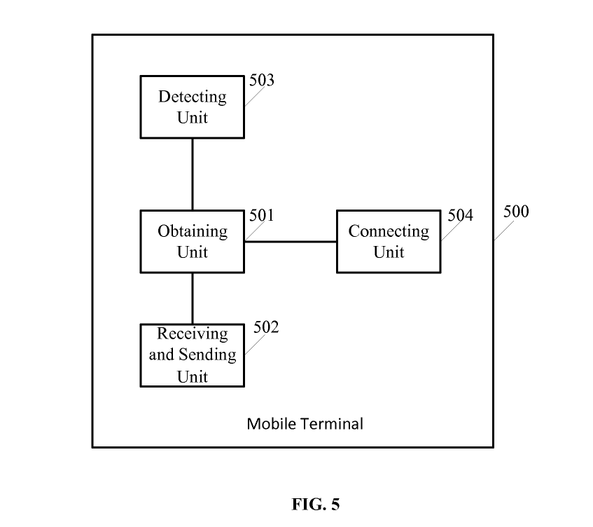

FIG. 5 illustrates a structure diagram of an exemplary mobile terminal consistent with the disclosed embodiments. As shown in FIG. 5, the mobile terminal 500 may include an obtaining unit 501, a receiving and sending unit 502, a detecting unit 503 and a connecting unit 504.

The obtaining unit 501 is configured to obtain a user identifier stored in a portable terminal which establishes a communication connection with the mobile terminal.

The receiving and sending unit 502 is configured to send the user identifier to a payment platform server, and receive prompt information sent from the payment platform server, where the prompt information is used to prompt the mobile terminal to report payment information. The prompt information is information sent from the payment platform server to the mobile terminal when the user identifier is authenticated successfully by the payment platform server.

Further, the receiving and sending unit 502 is also configured to receive the payment information inputted by a user in response to the prompt information, and send the payment information to the payment platform server, such that the payment platform server can perform a payment operation based on the payment information, where the payment information includes a payment account, a payment amount and a beneficiary account.

The detecting unit 503 is configured to, before the obtaining unit 501 obtains the user identifier stored in the portable terminal, detect an identification authentication start instruction inputted by the user, respond to the identification authentication start instruction and trigger the obtaining unit 501 to obtain the user identifier stored in the portable terminal which establishes a communication connection with the mobile terminal.

The connecting unit 504 is configured to, before the detecting unit 503 detects the identification authentication start instruction, establish a communication connection with the portable terminal.

Correspondingly, the obtaining unit 501 may obtain the user identifier stored in the portable terminal via the communication connection established by the connecting unit 504.

Specifically, the connecting unit 504 is configured to establish the communication connection with the portable terminal via a headphone port of the mobile terminal; the connecting unit 504 is configured to establish the communication connection with the portable terminal via a charging port of the mobile terminal; the connecting unit 504 is configured to establish the communication connection with the portable terminal via a Bluetooth module of the mobile terminal; the connecting unit 504 is configured to establish the communication connection with the portable terminal via a Wi-Fi module of the mobile terminal; and the connecting unit 504 is configured to establish the communication connection with the portable terminal via an NFC module of the mobile terminal.

In certain embodiments, the receiving and sending unit 502 is also configured to, after receiving the payment information inputted by the user in response to the prompt information, send the payment information to the portable terminal, such that the portable terminal can encrypt the payment information using an encryption algorithm and an encryption key stored in the portable terminal, and send the encrypted payment information to the mobile terminal.

Further, the receiving and sending unit 502 is also configured to receive the encrypted payment information sent from the portable terminal, and send the encrypted payment information to the payment platform server, such that the payment platform server can decrypt the encrypted payment information and perform a payment operation.

The user identifier stored in the portable terminal may include a user identifier that changes periodically.

In the mobile terminal shown in FIG. 5, by using the portable terminal to store the user identifier, a hardware-based security is implemented, thereby effectively improving the security of the mobile payment process.

The respective embodiments in the disclosure are described in a stepwise manner, the same or similar parts between the respective embodiments can be referred to with each other, and the emphasized explanations of the respective embodiments are the difference from other embodiments. Especially, for the apparatus embodiments, since they are substantially similar to the method embodiments, the description is comparatively simple, and relevant part can be referred to the explanation of the part of the method embodiments.

Those skilled in the art should understand that all or part of the steps in the above method may be executed by relevant hardware instructed by a program, and the program may be stored in a computer-readable storage medium such as a removable hard disk, a read-only memory (ROM), a random access memory (RAM), a magnetic disk, an optical disk, and so on.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed mobile payment methods, apparatuses, and systems, the mobile terminal obtains the user identifier (ID) stored in the portable terminal which establishes the communication connection with the mobile terminal. The mobile terminal sends the user identifier to the payment platform server. The payment platform server authenticates the user identifier, and sends the prompt information to the mobile terminal after the authentication is successful, where the prompt information is used to prompt the mobile terminal to report the payment information. After the mobile terminal receives the payment information inputted by the user in response to the prompt information, the mobile terminal sends the payment information to the payment platform server to cause the payment platform server to perform the payment operation, thereby effectively improving the security of the mobile payment process.

What is claimed is:

1. A mobile payment method for a mobile terminal, comprising:
obtaining, by the mobile terminal, a user identifier stored in a portable terminal which establishes a communication connection with the mobile terminal;
sending, by the mobile terminal, the user identifier to a payment platform server;
receiving, by the mobile terminal, prompt information sent from the payment platform server, wherein the prompt information is used to prompt the mobile terminal to report payment information after the payment platform server authenticates successfully the user identifier sent from the mobile terminal;
receiving, by the mobile terminal, the payment information inputted by a user in response to the prompt information; and
sending, by the mobile terminal, the payment information to the payment platform server to cause the payment platform server to perform a payment operation based on the payment information, wherein the payment information includes a payment account, a payment amount and a beneficiary account.

2. The method according to claim 1, before obtaining a user identifier stored in a portable terminal which establishes a communication connection with the mobile terminal, further including:
detecting, by the mobile terminal, an identification authentication start instruction inputted by the user;
responding to, by the mobile terminal, the identification authentication start instruction; and
performing, by the mobile terminal, the steps for obtaining the user identifier stored in the portable terminal which establishes the communication connection with the mobile terminal.

3. The method according to claim 2, before detecting an identification authentication start instruction inputted by the user, further including:
establishing, by the mobile terminal, the communication connection with the portable terminal.

4. The method according to claim 3, wherein the communication connection with the portable terminal is established via one of the following interfaces:
a headphone port of the mobile terminal;
a charging port of the mobile terminal;
a Bluetooth module of the mobile terminal;
a wireless fidelity (Wi-Fi) module of the mobile terminal; and
a near field communication (NFC) module of the mobile terminal.

5. The method according to claim 4, after receiving the payment information inputted by a user in response to the prompt information, further includes:
sending, by the mobile terminal, the payment information to the portable terminal;
receiving, by the mobile terminal, the encrypted payment information sent from the portable terminal after the portable terminal receives the payment information sent from the mobile terminal and encrypts the payment information using an encryption algorithm and an encryption key stored in the portable terminal; and
sending, by the mobile terminal, the encrypted payment information to the payment platform server to cause the payment platform server to decrypt the encrypted payment information and perform the payment operation.

6. The method according to claim 4, wherein:
the user identifier stored in the portable terminal includes a user identifier that changes periodically.

7. A mobile terminal, comprising:
an obtaining unit configured to obtain a user identifier stored in a portable terminal which establishes a communication connection with the mobile terminal; and
a receiving and sending unit configured to:
send the user identifier to a payment platform server;
receive prompt information sent from the payment platform server, wherein the prompt information is used to prompt the mobile terminal to report payment information, and the prompt information is information sent from the payment platform server to the mobile terminal when the user identifier is authenticated successfully by the payment platform server;
receive the payment information inputted by a user in response to the prompt information; and
send the payment information to the payment platform server to cause the payment platform server to perform a payment operation based on the payment information, wherein the payment information includes a payment account, a payment amount, and a beneficiary account.

8. The mobile terminal according to claim 7, further includes:
a detecting unit configured to, before the obtaining unit obtains the user identifier stored in the portable terminal which establishes the communication connection with the mobile terminal, detect an identification authentication start instruction, respond to the identification authentication start instruction, and trigger the obtaining unit to obtain the user identifier stored in the portable terminal which establishes the communication connection with the mobile terminal.

9. The mobile terminal according to claim 8, further includes:
a connecting unit configured to, before the detecting unit detects the identification authentication start instruction, establish the communication connection with the portable terminal.

10. The mobile terminal according to claim 9, wherein the connecting unit is configured to establish the communication connection with the portable terminal via one of the following interfaces:
a headphone port of the mobile terminal;
a charging port of the mobile terminal;
a Bluetooth module of the mobile terminal;
a Wi-Fi module of the mobile terminal; and
a near field communication (NFC) module of the mobile terminal.

11. The mobile terminal according to claim 10, wherein the receiving and sending unit is also configured to:
after receiving the payment information inputted by the user in response to the prompt information, send the payment information to the portable terminal to cause the portable terminal to encrypt the payment information using an encryption algorithm and an encryption key and send the encrypted payment information to the mobile terminal; and
receive the encrypted payment information sent from the portable terminal, and send the encrypted payment information to the payment platform server to cause the payment platform server to decrypt the encrypted payment information and perform the payment operation.

12. The mobile terminal according to claim 10, wherein:
the user identifier stored in the portable terminal includes a user identifier that changes periodically.

13. A mobile payment system, comprising:
a portable terminal configured to store a user identifier;
a mobile terminal configured to:
obtain the user identifier stored in the portable terminal;
send the user identifier to a payment platform server;
receive payment information inputted by a user in response to prompt information; and
send the payment information to the payment platform server, wherein the payment information includes a payment account, a payment amount and a beneficiary account; and
the payment platform server configured to:
receive the user identifier sent from the mobile terminal;
authenticate the user identifier, wherein:
when an authentication is successful, the payment platform server sends the prompt information to the mobile terminal, and the prompt information is used to prompt the mobile terminal to report the payment information;
receive the payment information sent from the mobile terminal; and
perform a payment operation based on the payment information.

14. The system according to claim 13, wherein, before obtaining the user identifier stored in the portable terminal, the mobile terminal is further configured to:
detect an identification authentication start instruction inputted by the user;
respond to the identification authentication start instruction; and
perform the steps for obtaining the user identifier stored in the portable terminal.

15. The system according to claim 14, wherein the mobile terminal is further configured to:
before detecting the identification authentication start instruction, establish the communication connection with the portable terminal.

16. The system according to claim 15, wherein the mobile terminal establishes the communication connection with the portable terminal via one of the following interfaces:
a headphone port of the mobile terminal;
a charging port of the mobile terminal;
a Bluetooth module of the mobile terminal;
a Wi-Fi module of the mobile terminal; and
a near field communication (NFC) module of the mobile terminal.

17. The system according to claim 16, wherein:
the portable terminal is also configured to:
store an encryption algorithm and an encryption key;
after receiving the payment information sent from the mobile terminal, encrypt the payment information using the encryption algorithm and the encryption key to obtain the encrypted payment information; and
send the encrypted payment information to the mobile terminal;
the mobile terminal is also configured to:
after receiving the payment information inputted by the user in response to the prompt information, send the payment information to the portable terminal;
receive the encrypted payment information sent from the portable terminal; and
send the encrypted payment information to the payment platform server; and
the payment platform server is also configured to:
receive the encrypted payment information sent from the mobile terminal; and
decrypt the encrypted payment information and perform the payment operation.

18. The system according to claim 13, wherein:
the user identifier stored in the portable terminal includes a user identifier that changes periodically.
